(19) United States
(12) Patent Application Publication
(10) Pub. No.: US 2026/0152978 A1
(43) Pub. Date: Jun. 4, 2026

(54) LOCK DEVICE FOR OPENING/CLOSING BODY

(71) Applicant: PIOLAX, INC., Kanagawa (JP)

(72) Inventor: Hisashi NAKASONE, Kanagawa (JP)

(73) Assignee: PIOLAX, INC., Kanagawa (JP)

(21) Appl. No.: 19/123,400

(22) PCT Filed: Oct. 26, 2023
(86) PCT No.: PCT/JP2023/038759

§ 371 Date: Apr. 23, 2025

(30) Foreign Application Priority Data
Nov. 4, 2022 (JP) 2022-177128

(51) Int. Cl. E05B 83/30; B60R 7/06; E05B 85/06; E05C 9/04

(52) U.S. Cl. CPC E05B 83/30; B60R 7/06; E05B 85/06; E05C 9/043

(57) ABSTRACT

A lock device for an opening and closing body includes: a base member; and an operating member. The operating member includes an operating plate portion, an operating portion, a first load transmission wall portion, a stopper portion, and a second load transmission wall portion. The second load transmission wall portion has a base end connected to the first load transmission wall portion and/or the stopper portion, and includes an extension portion including a portion obliquely extending toward the operating plate portion and a connecting portion that connects the extension portion to the operating plate portion. A gap is formed between the first load transmission wall portion, the extension portion and the connecting portion of the second load transmission wall portion, and the operating plate portion.

### TECHNICAL FIELD

The present invention relates to a lock device for an opening and closing body in which the lock device locks the opening and closing body in a closed state and the opening and closing body is attached to an opening of a fixed body to be openable and closable.

### BACKGROUND ART

For example, an opening and closing body such as a lid is attached to an opening formed in a fixed body such as a glove box of an automobile to be openable and closable. A lock device that locks the opening and closing body when the opening and closing body is closed and releases the locking when the opening and closing body is opened is provided between the opening and the opening and closing body.

For example, Patent Literature 1 described below discloses a lock device including a base member fixed to an opening and closing member, an operating member supported by the base member, a rotation member that is supported by the base member to be rotatable and rotates in response to an operation of the operating member, and a first rod and a second rod of which base ends are connected to the rotation member.

The operating member includes a plate-shaped base portion, a transmission portion that has a columnar shape protruding from a rear side of the base portion and engages with the first rod to transmit an operating force, and a rotation stopping portion that protrudes from a side surface of the transmission portion.

### CITATION LIST

### Patent Literature

Patent Literature 1: JP2019-23379A

### SUMMARY OF INVENTION

### Technical Problem

In the lock device disclosed in Patent Literature 1, when a user rotates the operating member in a direction away from the base member, the rotation stopping portion provided in the operating member is caught by the base member at a predetermined rotation position so that rotation of the operating member is restricted. Then, an operating load is transmitted to the transmission portion via the rotation stopping portion, and is transmitted to a base end side of the transmission portion.

Here, the operating load is concentrated to a connecting portion between the base end of the transmission portion and the base portion (a boundary portion between the base end of the transmission portion and the base portion), and thus the transmission portion or the base portion may be damaged. Therefore, in the above-described lock device, as shown in FIG. 2 of Patent Literature 1, the connecting portion between the transmission portion and the base portion is reinforced by a plurality of reinforcing ribs having an approximately triangular plate shape.

However, the reinforcing ribs may not be able to sufficiently prevent damage of the transmission portion, the base portion, and the like when the operating member is maximally rotated with respect to the base member.

Accordingly, an object of the present invention is to provide a lock device for an opening and closing body in which the lock device is capable of sufficiently preventing damage of an operating member when the operating member is maximally rotated with respect to a base member.

### Solution to Problem

To achieve the above-described object, according to the present invention, there is provided a lock device for an opening and closing body configured to be attached to an opening of a fixed body to be openable and closable, the lock device including: a lock portion provided in one of the fixed body or the opening and closing body; a lock member that is disposed in another of the fixed body or the opening and closing body and that is configured to engage with or disengage from the lock portion; a base member fixed to the other of the fixed body or the opening and closing body; and an operating member that is supported by the base member via a pivotally supporting portion to be rotatable and that is configured to operate the lock member, in which the operating member includes an operating plate portion extending in a plate shape, an operating portion provided in the operating plate portion, a first load transmission wall portion protruding from a rear side of the operating plate portion, a stopper portion provided to be connected to the first load transmission wall portion, and a second load transmission wall portion provided on the rear side of the operating plate portion, the second load transmission wall portion has a base end connected to the first load transmission wall portion and/or the stopper portion, and includes an extension portion including a portion obliquely extending toward the operating plate portion and a connecting portion that connects the extension portion to the operating plate portion, the base member includes a stopper receiving portion that is capable of coming into contact with the stopper portion and that is configured to restrict rotation of the operating member, and a gap is formed between the first load transmission wall portion, the extension portion and the connecting portion of the second load transmission wall portion, and the operating plate portion.

### Advantageous Effects of Invention

According to the present invention, when the operating member is maximally rotated with respect to the base member by operating the operating portion, the stopper portion comes into contact with the stopper receiving portion so that the stopper portion receives an operating load. A part of the operating load is transmitted to the operating plate portion via one of the first load transmission wall portion or the second load transmission wall portion, and the remaining part of the operating load is transmitted to the operating plate portion via another of the first load transmission wall portion or the second load transmission wall portion. As a result, since the operating load can be dispersed to two paths of a path on the first load transmission wall portion side and a path on the second load transmission wall portion side, rigidity of the operating member is enhanced, and damage during operation of the operating member can be sufficiently prevented.

### BRIEF DESCRIPTION OF DRAWINGS

FIG. 1 is an exploded perspective view illustrating a first embodiment of a lock device for an opening and closing body according to the present invention.

FIG. 2 is an enlarged exploded perspective view of main portions of the lock device.

FIG. 3 is an enlarged perspective view of an operating member configuring the lock device viewed from a direction different from FIG. 2.

FIG. 4 is a rear view of the operating member.

FIG. 5 is a cross-sectional view taken along an arrow line D-D in FIG. 3.

FIG. 6 is a cross-sectional view taken along an arrow line E-E in FIG. 4.

FIG. 7 is an assembly perspective view of the lock device according to the present invention.

FIG. 8 is a cross-sectional view taken along an arrow line G-G in FIG. 7.

FIG. 9 is a cross-sectional view when the operating member is operated with respect to a base member in a state shown in FIG. 8.

FIG. 10 is an explanatory view of a state in which the opening and closing body is closed by the lock device according to the present invention.

FIG. 11 is an explanatory view of a state in which the opening and closing body is opened by the lock device.

FIG. 12 illustrates a second embodiment of a lock device for an opening and closing body according to the present invention and is an enlarged perspective view of an operating member configuring the lock device.

FIG. 13 is an enlarged perspective view of the operating member viewed from a direction different from FIG. 12.

FIG. 14 is a cross-sectional view when the operating member is operated with respect to a base member in the lock device according to the second embodiment.

FIG. 15 illustrates a third embodiment of a lock device for an opening and closing body according to the present invention and is an enlarged perspective view of an operating member configuring the lock device.

FIG. 16 is a cross-sectional view of the lock device.

FIG. 17 is a cross-sectional view when the operating member is operated with respect to the base member in the lock device in a state shown in FIG. 16.

### DESCRIPTION OF EMBODIMENTS

### First Embodiment of Lock Device for Opening and Closing Body

Hereinafter, a first embodiment of a lock device for an opening and closing body according to the present invention will be described with reference to the drawings.

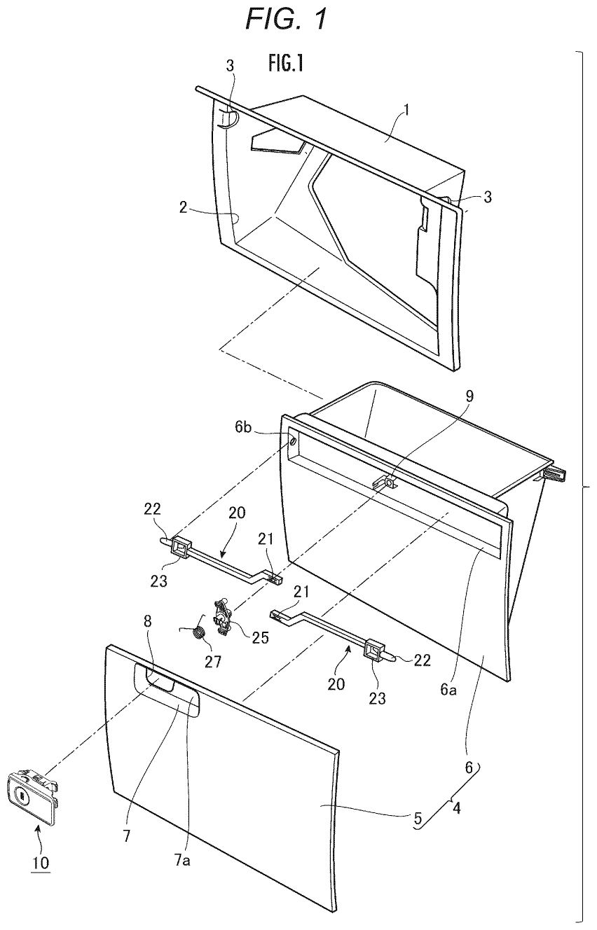

As shown in FIG. 1, a lock device 10 for an opening and closing body (hereinafter, referred to as “lock device 10”) according to the embodiment is a device used in an opening and closing lock of the opening and closing body 4 such as a glove box attached to an opening 2 of a fixed body 1 such as an instrument panel of a vehicle to be openable and closable.

As shown in FIGS. 1, 2, 10, and the like, the lock device 10 of the embodiment generally includes a pair of lock portions 3 and 3 provided in the opening portion 2 of the fixed body 1, a pair of lock members 20 and 20 that are disposed in the opening and closing body 4 and engage with and disengage from the pair of lock portions 3 and 3, a rotation member 25 that is supported to the opening and closing body 4 to be rotatable and causes the pair of lock members 20 and 20 to slide in conjunction, biasing means (torsion spring 27) that biases the pair of lock members 20 and 20 in a direction of engaging with the pair of lock portions 3 and 3, a base member 30 fixed to the opening and closing body 4, and an operating member 50 that is supported to the base member 30 via a pivotally supporting portion to be rotatable and operates the pair of lock members 20 and 20.

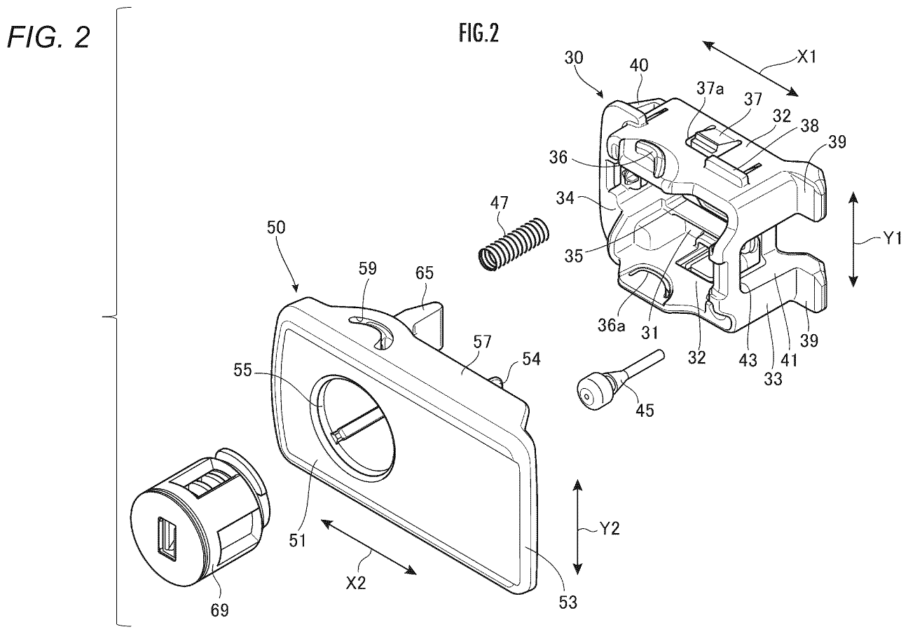

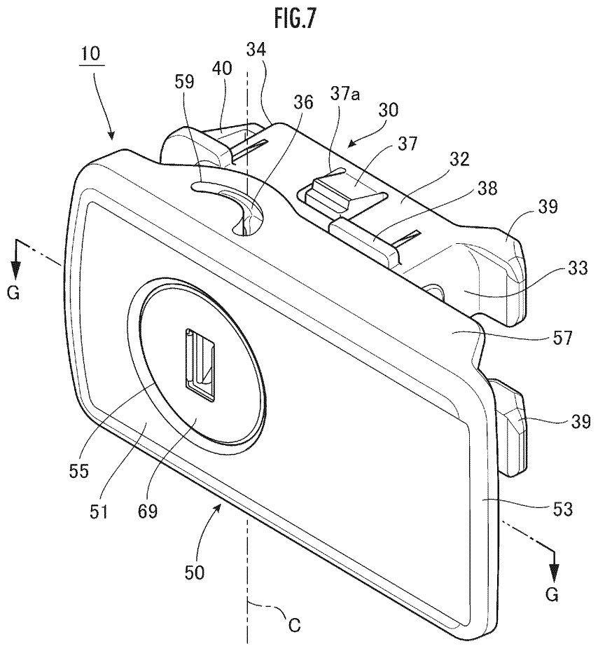

Note that, in the embodiment, as shown in FIGS. 2 and 7, a support protrusion 36 provided in the base member 30, a support groove 59 provided in the operating member 50 and the “pivotally supporting portion” of the present invention are configured.

As shown in FIG. 1, in the embodiment, the lock portions 3 and 3 each having a hole shape are provided in inner surfaces of the opening 2 of the fixed body 1 on both sides in a width direction.

As shown in FIG. 1, the opening and closing body 4 in the embodiment includes an outer member 5 disposed on a cabin inner side, and an inner member 6 disposed on a rear side of the outer member 5. An accommodating recess 7 having a horizontally long rectangular recess shape is formed on one side of the outer member 5 in the width direction and above the outer member 5.

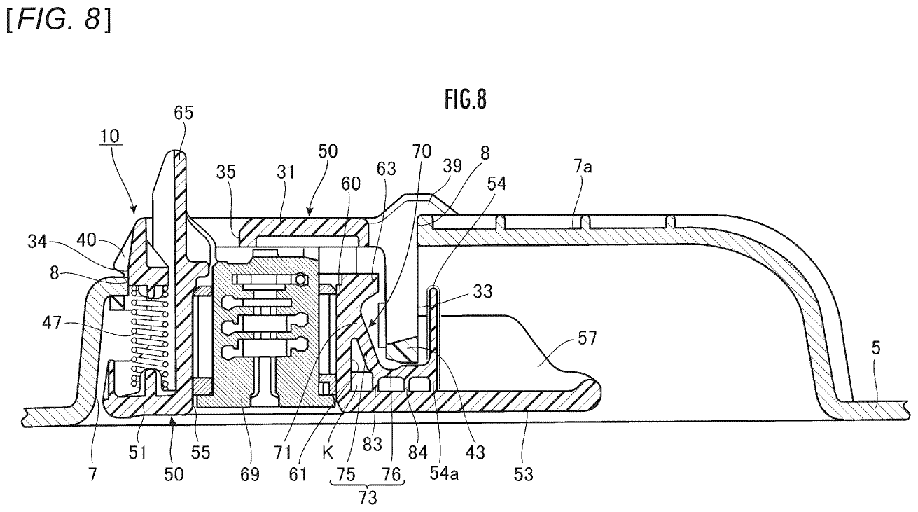

The base member 30 and the operating member 50 are accommodated in the accommodating recess 7 (refer to FIG. 8). A long hole-shaped attachment hole 8 is formed in a bottom 7a of the accommodating recess 7. The base member 30 is attached from a front side of the attachment hole 8.

Note that the “front side” described above or a “front surface side” means a side or a surface positioned in a direction in which an opening and closing body is opened from an opening of a fixed body of a vehicle or the like. When the fixed body is provided in the vehicle, a vehicle interior space side of the vehicle may be referred to as the “front side” or the “front surface side”. A “rear side” or a “rear surface side” means a side or a surface located on a side opposite to the “front side” or the “front surface side”, that is, in a direction in which the opening and closing body is closed.

“Front side”, “front surface side”, “rear side”, and “rear surface side” described above are not limited to those in the attachment hole and has the same meaning in other members to be described below (the base member 30, the operating member 50, and the like).

The inner portion 6 has a box shape opened upward as a whole as shown in FIG. 1. A lock arrangement recess 6a having a horizontally long recessed shape is provided in an upper portion of the inner member 6 on a front surface side facing the outer member 5 side (a front side) and the pair of lock members 20 and 20 are disposed to be capable of sliding therein. Each of lock inserting holes 6b and 6b is formed on both sides of the lock arrangement recess 6a in a longitudinal direction

A rotation member support portion 9 that rotationally supports the rotation member 25 protrudes from a front surface side of a bottom surface of the lock arrangement recess 6a.

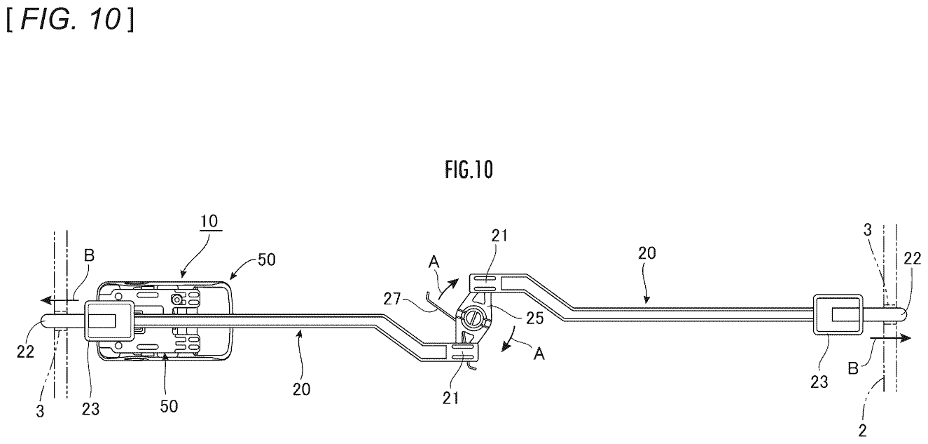

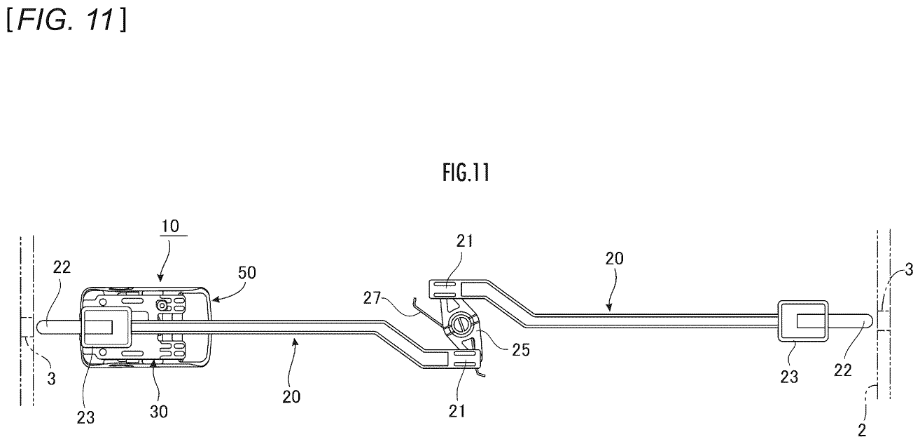

As shown in FIGS. 1 and 10, the pair of lock members 20 and 20 in the embodiment have the same shape, are bent in a crank shape at a base end 21 side, linearly extend toward a tip end side, and has tip ends 22 that engage with or disengage from each of the lock portions 3 (refer to FIGS. 10 and 11). A frame-shaped portion 23 having a quadrangular frame shape is provided on the tip end 22 side of each of the lock members 20.

The rotation member 25 described above has an approximately rhombus shape with a long axis (refer to FIG. 10), in which an intermediate portion thereof in a longitudinal direction is supported by the rotation member support portion 9 to be rotatable and both end portions in the longitudinal direction are each connected to the base ends 21 and 21 of the pair of lock members 20 and 20. By rotating the rotation member 25 in a predetermined direction, the pair of lock members 20 and 20 slide in conjunction via the rotation member 25.

The torsion spring 27 is mounted on the rotation member 25. Therefore, as indicated by an arrow A direction in FIG. 10, the rotation member 25 is rotationally biased and the tip ends 22 and 22 of the pair of lock members 20 and 20 are biased in a direction of engaging with the pair of lock portions 3 and 3 (an arrow B direction in FIG. 10). Note that the tip ends 22 and 22 of the pair of lock members 20 and 20 are each inserted out of the lock inserting holes 6b and 6b provided in the lock arrangement recess 6a.

Next, the base member 30 will be described in detail with reference to FIGS. 2, 7 to 9, and the like.

The base member 30 of the embodiment includes a bottom wall 31 having an elongated plate shape that is long in one direction, a pair of side walls 32 and 32 that are erected from both edges of a long side of the bottom wall 31 and extend in an extension direction of the bottom wall 31, a connecting wall 33 that is disposed on one end side of the bottom wall 31 in a longitudinal direction and connects the pair of side walls 32 and 32 to each other, and a connecting wall 34 that is disposed on another side of the bottom wall 31 in the longitudinal direction and connects the pair of side walls 32 and 32 to each other, and has an approximately long box shape in which a side of a ceiling (an upper side) opposite to the bottom wall 31 is opened.

Note that, in the following description, a direction of extension of the bottom wall 31 is set as an “extension direction X1”, and a direction orthogonal to the extension direction X1 is set as a “width direction Y1” (the same meaning is used in the base member 30 itself and each portion other than the bottom wall 31 configuring the base member 30).

A slide groove 35 that receives an operating lever 65 (refer to FIG. 2) of the operating member 50 to be capable of sliding is formed in the bottom wall 31.

The support protrusion 36 having an approximately circular arc shape protrudes outward from an outer surface of each of the side walls 32 at a position on an upper side (side opposite to the bottom wall 31) and near the connecting wall 34. Each support protrusion 36 is inserted from an inner side of the support groove 59 of the operating member 50, and the operating member 50 is supported by the base member 30 to be rotatable.

An elastic engagement piece 37 formed to be flexibly deformable via a U-shaped slit 37a, and a rib 38 protruding outward from a position adjacent to the elastic engagement piece 37 are each provided at a position of each of the side walls 32 near the bottom wall 31. The elastic engagement piece 37 engages with a rear side circumferential edge of the attachment hole 8, and the rib 38 engages with a front side circumferential edge of the attachment hole 8.

A pair of hooks 39 and 39 are provided to protrude from both sides of the connecting wall 33 on the bottom wall 31 side in the width direction Y1. A pair of elastic engagement claws 40 and 40 are provided from both sides of the connecting wall 34 on the bottom wall 31 side in the width direction Y1. As shown in FIG. 8, the pair of hooks 39 and 39 and the pair of elastic engagement claws 40 and 40 engage with the rear side circumferential edge of the attachment hole 8.

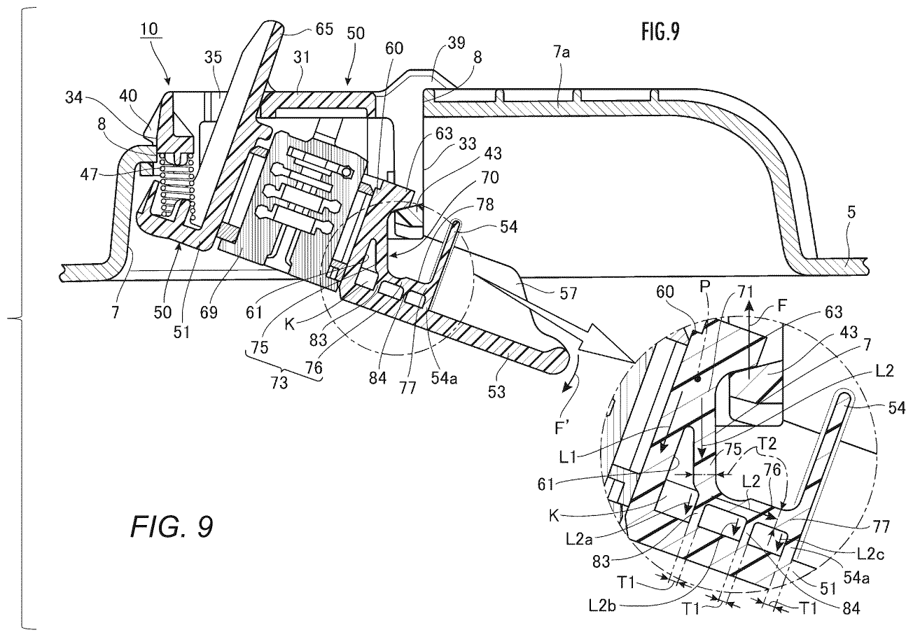

The base member 30 includes a stopper receiving portion 43 that can come into contact with a stopper portion 63 provided in the operating member 50 (refer to FIG. 9) and restricts rotation of the operating member 50.

In the embodiment, a notch 41 is formed as a notch in an intermediate portion of the connecting wall 33 in the width direction Y1 from the bottom wall 31 toward a ceiling opening, and the stopper receiving portion 43 is formed in the connecting wall 33 on an opposite side of the bottom wall 31 via the notch 41.

A rubber damper 45 (refer to FIG. 2) is mounted on a corner on one end side of the base member 30 in the extension direction XI. Tapping sound generated when an operating portion 53 of the operating member 50 rotates in a direction toward the base member 30 and the bottom 7a of the accommodating recess 7 is reduced by the damper 45. A coil spring 47 is disposed in a corner of the base member 30 on another end side in the extension direction X1.

Next, the operating member 50 will be described with reference to FIGS. 2 to 9, and the like.

The operating member 50 includes an operating plate portion 51 extending in a plate shape, the operating portion 53 provided in the operating plate portion 51, a first load transmission wall portion 60 (hereinafter, simply referred to as “first transmission wall portion 60”) protruding from a rear side of the operating plate portion 51 (a side facing the base member 30), the stopper portion 63 provided to be connected to the first transmission portion 60, and a second load transmission wall portion (hereinafter, simply referred to as “second transmission wall portion 70”) provided on the rear side of the operating plate portion 51.

Note that, in the present invention, the stopper portion 63 provided to be connected to the first transmission wall portion 60 means that the stopper portion 63 is directly connected to and is formed integrally with the first transmission wall portion 60.

The operating member 50 in the embodiment has an elongated shape that is long in one direction as a whole, and includes the operating plate portion 51 that extends in a plate shape by a predetermined length and has an approximately elongated plate shape.

Note that, in the following description, a direction of extension of the operating plate portion 51 is set as an “extension direction X2”. A direction parallel to an axial direction C (a direction along an axial center) of a pivotally supporting portion (the support protrusion 36 and the support groove 59) shown in FIG. 7 means a “width direction” in the present invention, and is set as a “width direction Y2”. The “width direction Y2” is also referred to as a direction orthogonal to the extension direction X2. Note that the extension direction X2 and the width direction Y2 has the same meaning in the operating member 50 itself and each portion other than the operating plate portion 51 (the second transmission wall portion 70 and the like) configuring the operating member 50.

The operating portion 53 as a portion that is gripped by an operator when rotationally operating the operating member 50 is provided on one end (tip end) side of the operating plate portion 51 in the extension direction X2. A partition wall portion 54 that partitions between the operating plate portion 51 and the operating portion 53 is erected from the rear side of the operating plate portion 51. That is, a range in the operating plate portion 51 from a position where the partition wall portion 54 is erected until one end in the extension direction X2 configures the operating portion 53.

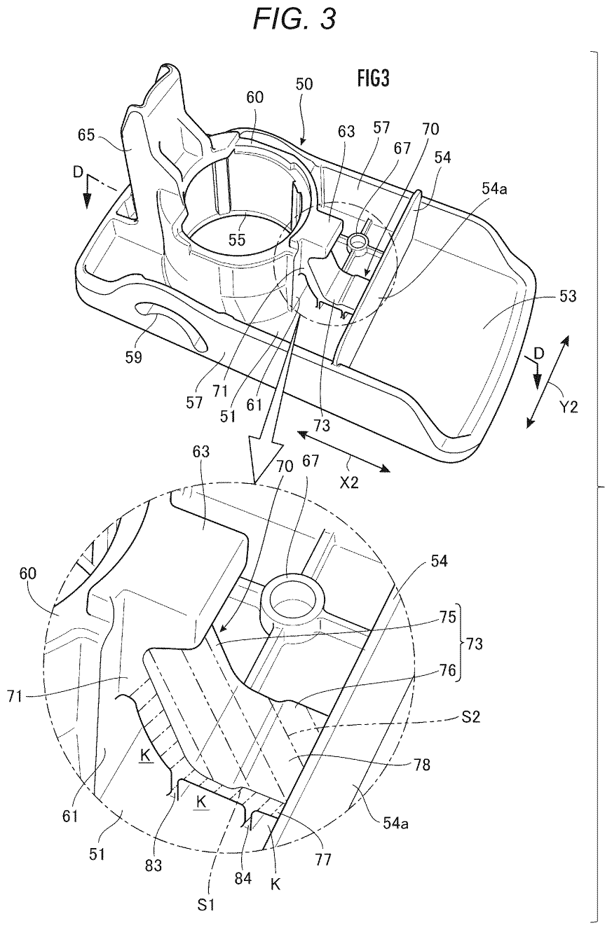

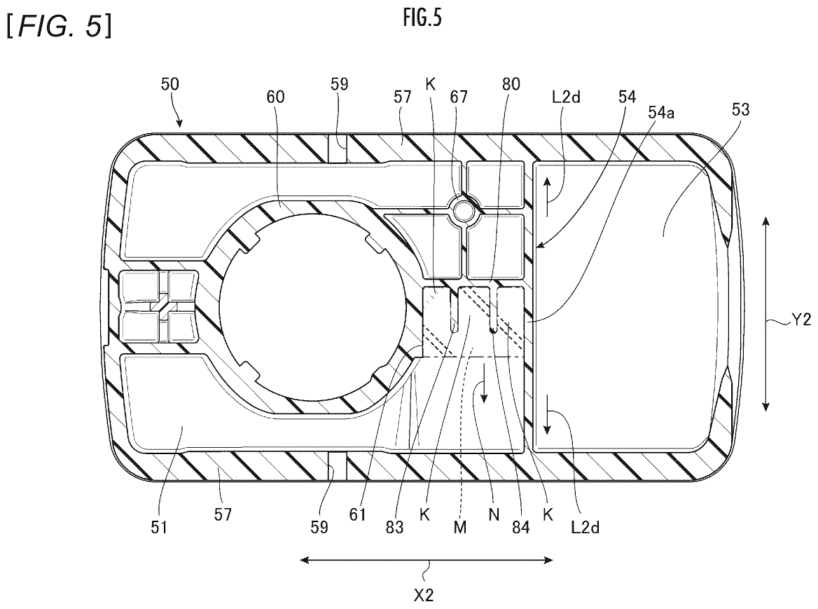

As shown in FIG. 5, the partition wall portion 54 is disposed facing a flat surface 61 of the first transmission wall portion 60 to be described below with a predetermined interval, and both end portions thereof in the width direction Y2 are connected to a pair of side walls 57 and 57 to be described below. As shown in FIG. 3, in the partition wall portion 54, a base end 54a in an erection direction is connected to a rear surface side of the operating plate portion 51.

A cylinder insertion hole 55 having a circular hole shape for inserting a key cylinder 69 is formed on another end (base end) side of the operating plate portion 51 in the extension direction X2.

The pair of side walls 57 and 57 extending along the extension direction X2 of the operating plate portion 51 are erected toward a rear side (toward the base member 30 side) from both edges of the operating plate portion 51 in the width direction Y2. The support groove 59 having an approximately circular arc groove shape is formed on a base end side of each of the side walls 57 in the extension direction X2.

A pair of the support protrusions 36 and 36 provided in the base member 30 are inserted from an inner side of the pair of support grooves 59 and 59, and the operating member 50 is supported by the base member 30 to be rotatable.

As a result, as shown in FIGS. 8 and 9, the operating member 50 rotates with respect to the base member 30 with the pivotally supporting portion set as a pivoting point so that the operating portion 53 moves toward and away from the base member 30 or the bottom 7a of the accommodating recess 7.

The coil spring 47 is compressed and interposed between another end of the operating member 50 in the extension direction X2 and another end of the base member 30 in the extension direction X1 (refer to FIG. 8).

Therefore, as shown in FIG. 9, when an operator grips the operating portion 53 and rotationally operates the operating member 50 with respect to the base member 30 to move away from the base member 30 or the bottom 7a of the accommodating recess 7 and then the operator releases the operating portion 53, the operating portion 53 is rotationally biased in a direction toward the base member 30 or the bottom 7a of the accommodating recess 7.

The first transmission wall portion 60 having an approximately cylindrical shape and into which the key cylinder 69 can be inserted protrudes (is provided to protrude) from a position that is the rear side of the operating plate portion 51 and a rear side circumferential edge of the cylinder insertion hole 55.

As shown in FIG. 9, when the operating member 50 is maximally rotated with respect to the base member 30 and the stopper portion 63 comes into contact with the stopper receiving portion 43 so that rotation of the operating member 50 is restricted, the first transmission wall portion 60 transmits an operating load F input via the stopper portion 63 to the operating plate portion 51 or the second transmission wall portion 70.

The flat surface 61 having a flat surface shape is formed on an outer surface facing one end side of the first transmission wall portion 60 in the extension direction X2.

The stopper portion 63 is provided to protrude from an outer surface facing one end in the extension direction X2 that is a tip end of the first transmission wall portion 60 in a protrusion direction. The stopper portion 63 is integrally and continuously formed with the first transmission wall portion 60, and provided to be connected to the first transmission wall portion 60.

As shown in FIG. 9, when the operating portion 53 is maximally rotated with respect to the base member 30 by gripping the operating portion 53 in a direction away from the base member 30 or the bottom 7a of the accommodating recess 7 against a biasing force of the coil spring 47, the stopper portion 63 comes into contact with the stopper receiving portion 43 and further rotation of the operating member 50 is restricted.

As shown in FIG. 3, the operating lever 65 is erected from a rear side near the other end (base end) of the operating plate portion 51 in the extension direction X2.

A part of the operating lever 65 is connected to the first transmission wall portion 60 at a position opposite to a stopper portion formed portion in a radial direction, and is erected higher than the tip end of the first transmission wall portion 60 in a protruding direction. The operating lever 65 is inserted out of a rear side of the slide groove 35 of the base member 30, and is inserted into the frame-shaped portion 23 of one of the lock member 20.

When the operating portion 53 of the operating member 50 is rotated in a direction away from the base member 30 or the bottom 7a of the accommodating recess 7, since the above-described operating lever 65 presses an inner surface of the frame-shaped portion 23 of one of the lock member 20, the tip ends 22 and 22 of the pair of lock members 20 and 20 slide in a direction to not engage with the pair of lock portions 3 and 3 of the fixed body 1 via the rotation member 25 (refer to FIG. 11).

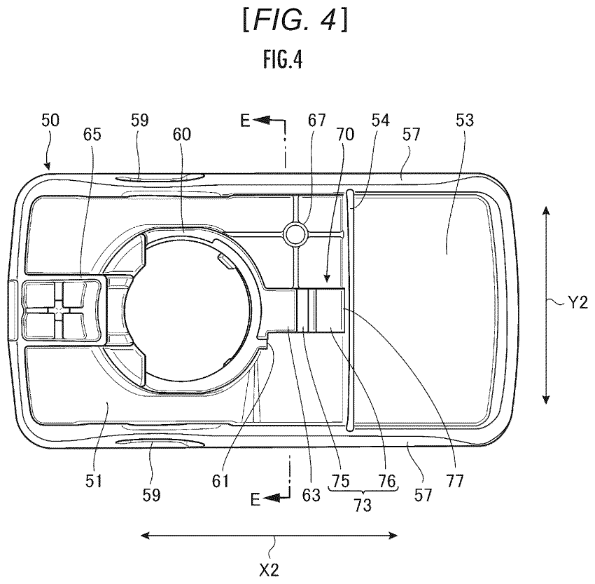

As shown in FIGS. 3 and 4, a damper contact portion 67 having an approximately cylindrical protrusion shape that comes into contact with the damper 45 (refer to FIG. 2) is provided to protrude at a position near the partition wall portion 54 that is the rear side of the operating plate portion 51 and one side thereof in the width direction Y2.

The damper contact portion 67 is a portion that comes into contact with the damper 45 mounted on the base member 30 when the operating portion 53 is rotationally biased by the coil spring 47 in a direction toward the base member 30 or the bottom 7a of the accommodating recess 7.

The second transmission wall portion 70 has a base end 71 connected to the stopper portion 63 and/or the first transmission wall portion 60, and includes an extension portion 73 having a portion obliquely extending toward the operating plate portion 51 and a connecting portion that connects the extension portion 73 to the operating plate portion 51.

In the embodiment, the base end 71 of the second transmission wall portion 70 is connected to a connecting portion between the first transmission wall portion 60 and the stopper portion 63 (a boundary portion between the first transmission wall portion 60 and the stopper portion 63). A first extension portion 75 obliquely extends from the base end 71 toward one end of the operating plate portion 51 in the extension direction X2. A second extension portion 76 extends from a tip end of the first extension portion 75 in the extension direction to be parallel with a planar direction of the operating plate portion 51 (a direction along a surface of the operating plate portion 51).

A tip end 77 of the second extension portion 76 in the extension direction is connected to the base end 54a of the partition wall portion 54. That is, in the embodiment, the base end 54a of the partition wall portion 54 configures a “connecting portion” in the present invention.

The first extension portion 75 configures a “portion obliquely extending toward the operating plate portion” in the present invention. The first extension portion 75 and the second extension portion 76 configure the “extension portion 73” in the present invention.

The extension portion 73 is formed in a constant width until reaching the tip end 77 from the base end 71 (a length in the width direction Y2 is constant).

An outer surface 78 of a tip end of the second extension portion 76 in the extension direction protrudes from a rear surface of the operating plate portion 51 to be higher than an outer surface of a base end in the extension direction.

When the damper 45 is mounted on the base member 30 as in the embodiment, as shown in FIG. 8, while the operating portion 53 is rotationally biased in a direction toward the base member 30 or the bottom 7a of the accommodating recess 7 by the coil spring 47, the outer surface 78 is disposed to face a front side end surface of the connecting wall 33 of the base member 30 with a small gap.

Meanwhile, when the damper 45 is not mounted on the base member 30, while the operating portion 53 is rotationally biased toward the base member 30 and the like by the coil spring 47, the outer surface 78 comes into contact with the front side end surface of the connecting wall 33 of the base member 30.

As shown in FIGS. 3, 5, 6, and 9, in the lock device 10, a gap K is formed between the first transmission wall portion 60, the extension portion 73 and the connecting portion of the second transmission wall portion 70, and the operating plate portion 51.

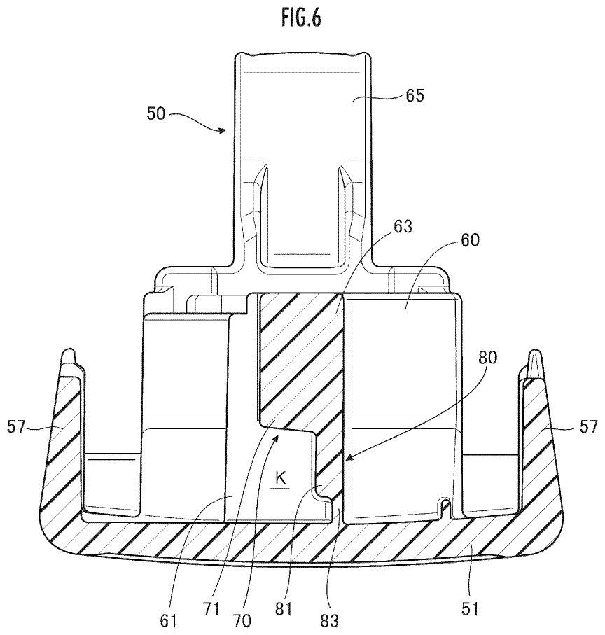

As shown in FIGS. 5 and 6, a side wall portion 80 that connects the operating plate portion 51 to the first transmission wall portion 60 is provided in one side of the second transmission wall portion 70 in the width direction Y2.

The side wall portion 80 of the embodiment connects the flat surface 61 of the first transmission wall portion 60, the first extension portion 75 and the second extension portion 76 configuring the extension portion 73, the partition wall portion 54, and the operating plate portion 51 to each other. As shown in FIG. 6, a thick wall portion 81 thicker than a base end connected to the operating plate portion 51 is provided at a part of the side wall portion 80 on the flat surface 61 side of the first transmission wall portion 60.

The above-described gap K has the following configuration in a relationship with the above-described side wall portion 80.

That is, the gap K in the embodiment is surrounded by the flat surface 61 of the first transmission wall portion 60, the first extension portion 75 and the second extension portion 76 configuring the extension portion 73, the partition wall portion 54, the operating plate portion 51, and the side wall portion 80, and in the operating plate portion 51, one side in the width direction Y2 is closed by the side wall portion 80 and another side in the width direction Y2 is opened.

Connecting ribs 83 and 84 that connect the extension portion 73 to the operating plate portion 51 are provided in the tip end of the extension portion 73 (the tip end 77 of the second extension portion 76) on the first transmission wall portion 60 side of a connecting portion with the partition wall portion 54.

In the embodiment, as shown in FIGS. 3, 8, and 9, a connecting portion between the first extension portion 75 and the second extension portion 76 (a boundary portion between the first extension portion 75 and the second extension portion 76) and the operating plate portion 51 are connected to each other by the connecting rib 83. A predetermined portion of the second extension portion 76 in the extension direction and the operating plate portion 51 are connected to each other by the connecting rib 84.

Each of the connecting ribs 83 and 84 is provided to be orthogonal to a planar direction of the rear surface of the operating plate portion 51 (a direction along a surface of the rear surface of the operating plate portion 51). Each of the connecting ribs 83 and 84 extends over the entire region of the extension portion 73 in the width direction Y2, and one end in the width direction Y2 is connected to the side wall portion 80.

Note that the connecting ribs 83 and 84 also configure the “connecting portion” in the present invention. That is, in the embodiment, the connecting ribs 83 and 84, and the base end 54a of the partition wall portion 54 described above configure the “connecting portion” in the present invention.

The connecting portion is formed to be thinner than the thickness of the extension portion 73.

In the embodiment, as shown in FIG. 9, when the lock device 10 is viewed in a longitudinal cross section (a cross section taken along an arrow line G-G in FIG. 7), a thickness T1 of each of the base end 54a of the partition wall portion 54 configuring the connecting portion and the connecting ribs 83 and 84 is thinner than a thickness T2 of each of the first extension portion 75 and the second extension portion 76 configuring the extension portion 73.

The thickness T1 of the connecting portion means a size in the planar direction of the rear surface of the operating plate portion 51. Meanwhile, the thickness T2 of the extension portion 73 means a size in a direction intersecting the planar direction of the rear surface of the operating plate portion 51. That is, the thickness T2 of the second extension portion 76 is a size in a direction orthogonal to the planar direction of the rear surface of the operating plate portion 51, and the thickness T2 of the first extension portion 75 is a size in a direction obliquely intersecting the planar direction of the rear surface of the operating plate portion 51.

As shown in a partially enlarged perspective view in FIG. 3, when a surface area of the second transmission wall portion 70 when viewed from the width direction Y2 (a region surrounded by hatching with one-dot chain line) is set as S1 and a surface area of the second transmission wall portion 70 when viewed from a thickness direction (a region surrounded by hatching with two-dot chain line) is set as S2, a relationship of S1<S2 is satisfied.

Note that the above-described configuration can be expressed as follows.

Specifically, a surface area when the second transmission wall portion 70 is viewed from the planar direction of the rear surface of the operating plate portion 51 can be expressed as “S2” and a surface area when the second transmission wall portion 70 is viewed from a lateral side can be expressed as “S1”, and even then, S2 is set to be larger than S1.

In the lock device 10 described above, when the operating member 50 is rotated with respect to the base member 30 by operating the operating portion 53 and the stopper portion 63 comes into contact with the stopper receiving portion 43, the operating load F (refer to FIG. 9) from the stopper receiving portion 43 is input to the stopper portion 63.

A part of the operating load F is transmitted to the operating plate portion 51 via one of the first transmission wall portion 60 or the second transmission wall portion 70 and the remaining part of the operating load F is transmitted to the operating plate portion 51 via the other of the first transmission wall portion 60 or the second transmission wall portion 70, thereby dispersing the operating load F. A load dispersion aspect of the operating load F includes the following (1) to (3).

Specifically, as in the embodiment, when the base end 71 of the second transmission wall portion 70 is connected to the first transmission wall portion 60 and the stopper portion 63, (1) the above-described operating load F is simultaneously or almost simultaneously (with almost no lag) transmitted from the stopper portion 63 to both the first transmission wall portion 60 and the second transmission wall portion 70, thereby dispersing the operating load F.

When the base end 71 of the second transmission wall portion 70 is connected to only the first transmission wall portion 60, (2) the above-described operating load F is transmitted from the stopper portion 63 to the first transmission wall portion 60, and then is transmitted to the second transmission wall portion 70 via the first transmission wall portion 60, thereby dispersing the operating load F.

When the base end 71 of the second transmission wall portion 70 is connected to only the stopper portion 63, (3) the above-described operating load F is transmitted from the stopper portion 63 to the second transmission wall portion 70, and then is transmitted to the first transmission wall portion 60 with a slight delay or almost simultaneously, thereby dispersing the operating load F.

The dispersion aspect of the operating load F in the embodiment will be described in more detail.

Specifically, in a state shown in FIG. 8, when the operating member 50 is maximally rotated with respect to the base member 30 in a direction away from the base member 30 or the bottom 7a of the accommodating recess 7 as shown by an arrow F′ by gripping the operating portion 53, as shown in FIG. 9, the stopper portion 63 comes into contact with the stopper receiving portion 43 and further rotation of the operating member 50 is restricted. Then, the stopper portion 63 receives the operating load F from the stopper receiving portion 43.

Here, in the embodiment, since the base end 71 of the second transmission wall portion 70 is connected to both the first transmission wall portion 60 and the stopper portion 63, the operating load F is simultaneously or almost simultaneously transmitted to the first transmission wall portion 60 and the second transmission wall portion 70 so that the operating load F is dispersed (the load dispersion aspect of (1) in Paragraph 0084).

That is, as shown in FIG. 9, when the connecting portion (the boundary portion) between the first transmission wall portion 60 and the base end 71 of the second transmission wall portion 70 is set as a load branching portion P, the operating load F is branched at the load branching portion P, a part of the load is transmitted to the first transmission wall portion 60, and the remaining part of the load is transmitted to the second transmission wall portion 70.

Specifically, the operating load F is transmitted by two paths L1 and L2, that is, a first path L1 that passes the first transmission wall portion 60 (a path that mainly passes the flat surface 61 in the protrusion direction of the first transmission wall portion 60), and a second path L2 that passes the second transmission wall portion 70 (an oblique path that passes the first extension portion 75 and a path that passes the second extension portion 76 and is parallel to the planar direction of the operating plate portion 51).

In the lock device 10, as shown in FIGS. 5, 6, 9, and the like, since the gap K is formed between the first transmission wall portion 60, the extension portion 73 and the connecting portion of the second transmission wall portion 70, and the operating plate portion 51, load dispersion of the operating load F described above is reliably performed. That is, since the gap K described above is formed, the operating load F transmitted to the first transmission wall portion 60 side and the operating load F transmitted to the second transmission wall portion 70 side are prevented from joining again, The operating load F transmitted to the first transmission wall portion 60 is mainly transmitted to the operating plate portion 51 via the flat surface 61 of the first transmission wall portion 60 (refer to the first path L1).

Meanwhile, the operating load F transmitted to the second transmission wall portion 70 is mainly transmitted to the first extension portion 75 via the base end 71 (refer to the second path L2). Then, a part of the operating load F is transmitted to the operating plate portion 51 via the connecting rib 83 (refer to a second path L2a), and the remaining part is transmitted to the second extension portion 76.

A part of the operating load F transmitted to the second extension portion 76 is transmitted to the operating plate portion 51 via the connecting rib 84 (refer to a second path L2b), and the remaining part is transmitted to the partition wall portion 54 via the second extension portion 76.

A part of the operating load F transmitted to the partition wall portion 54 is transmitted to the operating plate portion 51 via the base end 54a of the partition wall portion 54 (refer to a second path L2c) and is transmitted to the pair of side walls 57 and 57 via both sides of the partition wall portion 54 in the width direction Y2 (refer to a second path L2d shown in FIG. 5).

As described above, in the embodiment, the operating load F branched from the load branching portion P and transmitted to the second transmission wall portion 70 is mainly transmitted via the second path L2 including the first extension portion 75 and the second extension portion 76, and until reaching the tip end 77 of the extension portion 73 in the extension direction, is branched and transmitted to the operating plate portion 51 via a plurality of paths (the second paths L2a, L2b, L2c, and L2d).

### Modification Example

The shape, the structure, the layout, and the like of the lock portion, the lock member, the base member, and the operating member configuring the lock device for the opening and closing body according to the present invention or each portion configuring each member (for example, the first and second load transmitting wall portions configuring the operating member) are not limited to the above-described aspects.

As described above, for example, the embodiment is applied to a structure in which a box-shaped glove box is attached to an opening of an instrument panel to be rotatable (here, the instrument panel is the “fixed body” and the glove box is the “opening and closing body”), but the embodiment may be applied to a structure in which a lid is attached to an opening of an instrument panel to be openable and closable (here, the instrument panel is the “fixed body” and the lid is the “opening and closing body”), and can be widely used for various opening and closing bodies that open and close the opening of the fixed body.

In the embodiment, the attachment hole 8 is formed in the opening and closing body 4, the lock members 20 are disposed in the opening and closing body 4 to be capable of sliding, but the attachment hole may be formed in the fixed body while the lock member may disposed in the fixed body side to be capable of sliding.

The lock portions 3 in the embodiment have a hole shape, but the lock portions may not have a hole shape, and may have a concave shape, a protrusion shape, a frame shape, or the like, and further, the lock portions may be provided in the opening and closing body and not in the opening of the fixed body.

The torsion spring 27 as the biasing means in the embodiment rotationally biases the rotation member 25 and biases the lock members 20 connected to the rotation member 25 in a direction to engage with the lock portions 3 (refer to FIG. 10), but a pull spring that pulls one of the lock members to the lock portion side may be the biasing means that biases the lock members in a direction to engage with the lock portions.

In the embodiment, when the operating member 50 described above is rotationally operated, one of the lock members 20 slides and the other lock member 20 slides via the rotation member 25, but the rotation member may be rotated by rotational operation of the operating member so that the pair of lock members slide (the aspect is employed in a third embodiment described below).

The opening and closing body 4 in the embodiment is configured of the outer member 5 and the inner member 6, and the opening and closing body may be configured of a single plate material.

In the embodiment, the operating member 50 is a so-called lateral pull handle in which the operating portion 53 is provided in one end of the operating plate portion 51 in the extension direction and attached to be rotatable in a lateral direction with respect to the base member 30. However, the operating member may be a so-called vertical pull handle in which the operating portion is provided above or below the operating plate portion and attached to be rotatable in a vertical direction with respect to the base member.

In the embodiment, the key cylinder 69 is disposed to be inserted into the first transmission wall portion 60. However, the key cylinder may not be inserted into the first load transmission wall portion (the aspect will be described in a second embodiment described below).

In the embodiment, the pivotally supporting portion is configured of the support protrusion 36 provided in the base member 30 and the support groove 59 provided in the operating member 50. However, the pivotally supporting portion may be configured of, for example, a shaft portion protruding from the operating member, a hole or a recess formed in the base member and pivotally supporting the shaft portion, and the like, and a pivotally supporting hole may be formed in the base member and the operating member so that a separate support shaft is inserted into the pivotally supporting hole.

In the embodiment, the base end 71 of the second transmission wall portion 70 is connected to the first transmission wall portion 60 and the stopper portion 63. However, the base end of the second load transmission wall portion may be connected to only the first load transmission wall portion (the aspect will be described in the third embodiment described below), or only the stopper portion. Note that a load dispersion aspect of the operating load herein is as described in Paragraphs 0085 and 0086.

### Operational Effect

Next, an operational effect of the lock device 10 having the above-described configuration will be described.

In the lock device 10, in a state in which the opening and closing body 4 is opened from the opening 2 of the fixed body 1, when the opening and closing body 4 is closed and the tip ends 22 and 22 of the pair of lock members 20 and 20 engage with the lock portions 3 and 3 of the fixed body 1, the opening and closing body 4 is locked while being closed (refer to FIG. 10).

Here, as shown in FIG. 9, when the operating portion 53 is rotated in a direction away from the base member 30 or the bottom 7a of the accommodating recess 7, as shown in FIG. 11, the tip end 22 of one of the lock members 20 is drawn in a direction to not engage with the lock portion 3 against a rotational biasing force of the rotation member 25, and in conjunction, the tip end 22 of the other lock member 20 is drawn in a direction to not engage with the lock portion 3 via the rotation member 25. As a result, the locking in which the opening and closing body 4 is closed is released, and the opening and closing body 4 can be opened from the opening 2 of the fixed body 1.

In the lock device 10, the operating member 50 is provided with the second transmission wall portion 70 having the base end 71 connected to the first transmission wall portion 60 and the stopper portion 63 and including the extension portion 73 that includes a portion (the first extension portion 75 and the second extension portion 76) obliquely extending toward the operating plate portion 51 and the connecting portion (the base end 54a of the partition wall portion 54 and the connecting ribs 83 and 84) that connects the extension portion 73 to the operating plate portion 51, and further, the gap K is formed between the first transmission wall portion 60, the extension portion 73 and the connecting portion of the second transmission wall portion 70, and the operating plate portion 51.

Therefore, as described in Paragraphs 0088 to 0097, when the operating member 50 is maximally rotated with respect to the base member 30 and the stopper portion 63 comes into contact with the stopper receiving portion 43 as shown in FIG. 9, the operating load F received by the stopper portion 63 is branched at the load branching portion P, a part of the operating load F is transmitted to the first transmission wall portion 60 (refer to the first path L1), and the remaining part is transmitted to the second transmission wall portion 70 and then transmitted to the operating plate portion 51 via the connecting portion (the base end 54a of the partition wall portion 54 and the connecting ribs 83 and 84) (refer to the second paths L2, L2a, L2b, L2c, and L2d).

As described above, in the lock device 10, the operating load F applied to the operating member 50 side via the stopper receiving portion 43 and the stopper portion 63 can be transmitted to operating plate portion 51 while being dispersed into two paths L1 and L2, that is, the first path L1 passing the first transmission wall portion 60 side, and the second path L2 passing the second transmission wall portion 70 side, and not transmitted via one path.

Accordingly, the operating load F is less likely to be concentrated to the connecting portion between the base end of the first transmission wall portion 60 and the operating plate portion 51, and it is possible to reduce damage of the connecting portion. As a result, rigidity and strength of the operating member 50 are enhanced, and thus it is possible to sufficiently prevent damage of the above-described connecting portion and the like during operation of the operating member 50. When the second transmission wall portion 70 or the gap K is not provided, since the operating load F cannot be reliably dispersed, the operating load F is concentrated to the connecting portion between the base end of the first transmission wall portion 60 and the operating plate portion 51, thereby being easily damaged.

In the embodiment, since the base end 71 of the second transmission wall portion 70 is connected to both the first transmission wall portion 60 and the stopper portion 63, during rotational operation of the operating member 50, an input portion of the operating load F (the stopper portion 63) and an output portion of the operating load F (the load branching portion P at which the operating load F is branched) can be brought closer.

Therefore, when maximally rotating the operating member 50 with respect to the base member 30, it is possible to lower a rotational moment caused by the operating load F that the stopper portion 63 receives, and it is possible to prevent damage of the connecting portion between the base end of the first transmission wall portion 60 and the operating plate portion 51.

In the lock device 10, since the gap K is formed between the first transmission wall portion 60, the extension portion 73 and the connecting portion of the second transmission wall portion 70, and the operation plate portion 51, during injection molding of the operating member 50, it is possible to prevent a sink mark on a design surface (front surface) of the operating plate portion 51, and it is possible to improve appearance.

In the embodiment, as shown in FIG. 5 and FIG. 6, the side wall portion 80 that connects the operating plate portion 51 to the first transmission wall portion 60 is provided in one side of the second transmission wall portion 70 in the width direction Y2.

According to the above-described aspect, by employing the above-described configuration, since it is possible to enhance rigidity of the second transmission wall portion 70, when the operating load F is dispersed and transmitted to the second transmission wall portion 70 during rotational operation of the operating member 50, it is possible to prevent damage of the second transmission wall portion 70.

Since the side wall portion 80 is disposed at one side of the second transmission wall portion 70 in the width direction Y2, during injection molding of the operating member 50, mold extraction can be performed (refer to an arrow N in FIG. 5), for example, by one mold M (refer to FIG. 5) that slides in a direction orthogonal to the surface of the side wall portion 80, and it is possible to improve manufacturability of the operating member 50. When a wall portion is provided at the center of the second transmission wall portion 70 in the width direction, it is necessary to perform mold extraction from both surfaces of the wall portion in a direction orthogonal to the wall portion, and thus the mold cost increases and it is difficult to improve manufacturability.

In the embodiment, as shown in FIG. 9, the connecting portion is formed to be thinner than the thickness of the extension portion 73.

According to the above-described aspect, the connecting portion (here, the base end 54a of the partition wall portion 54 and the connecting ribs 83 and 84) is formed to be thinner than the thickness of the extension portion 73, so that during injection molding of the operating member 50, it is possible to prevent a sink mark in the connecting portion (since the amount of solidification and shrinkage of synthetic resin is small) and to further improve appearance of the design surface of the operating plate portion 51.

In the embodiment, as shown in a partially enlarged perspective view in FIG. 3, when a surface area of the second transmission wall portion 70 when viewed from the width direction Y2 is set as S1 and a surface area of the second transmission wall portion 70 when viewed from a thickness direction is set as S2, a relationship of S1<S2 is satisfied.

According to the above-described aspect, by employing the above-described configuration, it is possible to form the second transmission wall portion 70 as wide as possible, and it is possible to improve rigidity of the second transmission wall portion 70. As a result, when the operating load F is dispersed and transmitted to the second transmission wall portion 70 during rotational operation of the operating member 50, it is possible to prevent damage of the second transmission wall 70.

As shown in FIGS. 3 to 5, in the embodiment, the partition wall portion 54 that partitions the operating plate portion 51 and the operating portion 53 is erected from the rear side of the operating plate portion 51, the tip end of the extension portion 73 (the tip end of the second extension portion 76) is connected to the partition wall portion 54, and the partition wall portion 54 (the base end 54a of the partition wall portion 54) configures the connecting portion.

According to the above-described aspect, by employing the above-described configuration, when the operating load F is transmitted to the second transmission wall portion 70 during rotational operation of the operating member 50, since the operating load F can be transmitted to the operating plate portion 51 using the partition wall portion 54, the operating load F can be further easily dispersed.

The partition wall portion 54 is a member that prevents fingers of an operator or the like from being inserted into the deep side of the operating member 50, and is often erected on the rear side of the operating plate portion 51. In the embodiment, by using the partition wall portion 54 as a part of the connecting portion, it is possible to reduce volume and the like of the connecting portion of the second transmission wall portion 70, and it is possible to realize simplification of shape and structure of the second transmission wall portion 70.

In the embodiment, as shown in FIGS. 3, 5, and 9, the connecting ribs 83 and 84 that connect the extension portion 73 to the operating plate portion 51 are provided in the tip end of the extension portion 73 on the first transmission wall portion 60 side of a connecting portion with the partition wall portion 54, and the connecting ribs 83 and 84 configure the connecting portion.

According to the above-described aspect, by employing the above-described configuration, the operating load F transmitted via the extension portion 73 of the second transmission wall portion 70 can be transmitted to the operating plate portion 51 via the connecting ribs 83 and 84 before reaching the partition wall portion 54, and the operating load F can be further easily dispersed.

### Second Embodiment of Lock Device for Opening and Closing Body

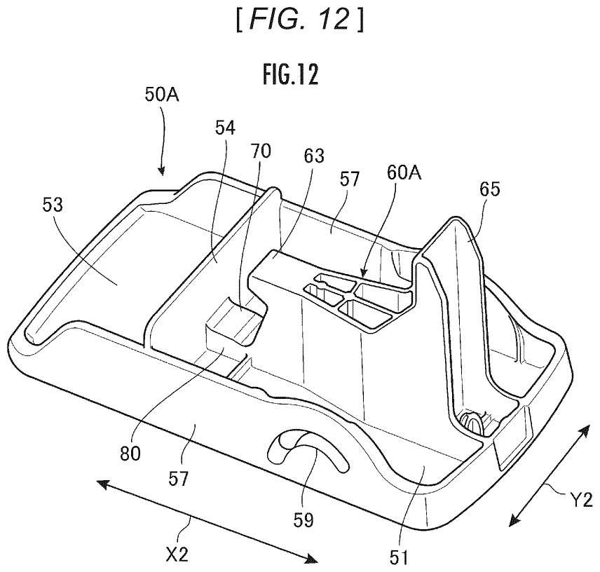

FIGS. 12 to 14 illustrate a second embodiment of the lock device for the opening and closing body according to the present invention. Note that the same reference sign will be given to substantially the same portion as in the above-described embodiment, and description thereof will be omitted.

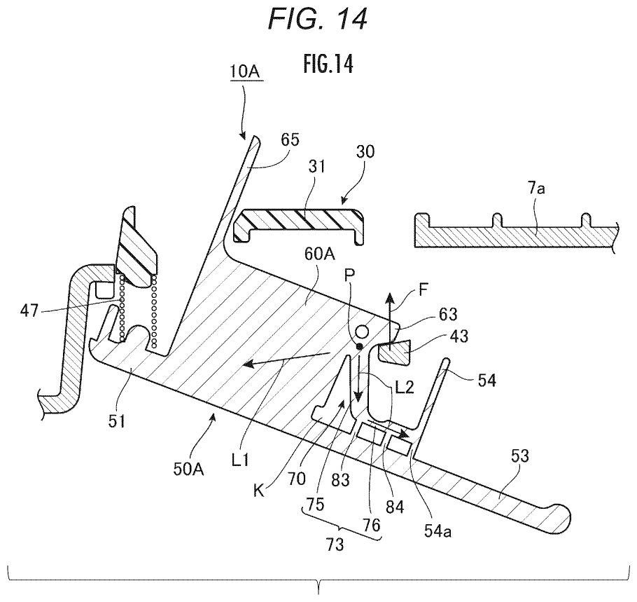

As shown in FIG. 14, a lock device 10A for an opening and closing body of the second embodiment (hereinafter, simply referred to as “lock device 10A”) is mainly different from the above-described embodiment in that a shape of a first load transmission wall portion 60A (hereinafter, simply referred to as “first transmission wall portion 60A”) provided in an operating member 50A is different.

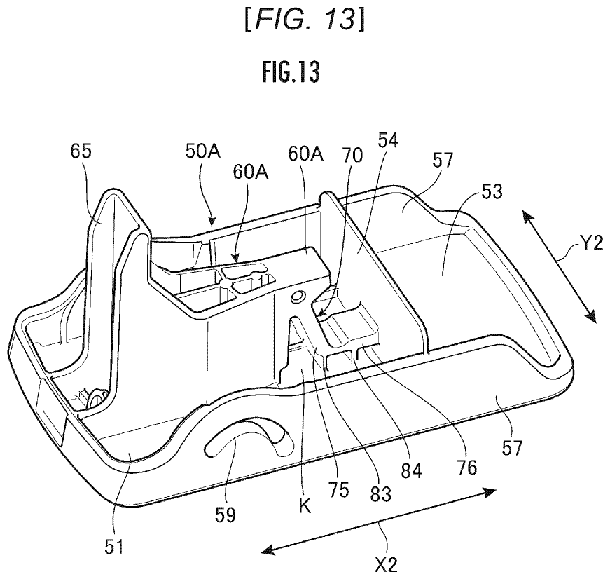

That is, as shown in FIGS. 12 and 13, unlike the approximately cylindrical shape of the first transmission wall portion 60 in the first embodiment, the first transmission wall portion 60A in the embodiment has a block shape extending along the extension direction X2 of the operating member 50A and is shaped so that the key cylinder 69 is not inserted therein.

When the operating member 50 is maximally rotated with respect to the base member 30 and the stopper portion 63 comes into contact with the stopper receiving portion 43 as shown in FIG. 14, a part of the operating load F received by the stopper portion 63 is transmitted to the first transmission wall portion 60, and the remaining part is transmitted to the second transmission wall portion 70. Here, since the first transmission wall portion 60A has the above-described shape, as indicated by the first path L1 in FIG. 14, the operating load F is transmitted obliquely inward and toward the rear surface side of the operating plate portion 51 and the other end side of the operating plate portion 51 in the extension direction X2.

That is, also in the embodiment, since the operating load F is dispersed into the first path L1 and the second path L2, the operating load F is not easily concentrated to the connecting portion between the base end of the first transmission wall portion 60 and the operating plate portion 51, thereby reducing damage of the connecting portion and enhancing rigidity and strength of the operating member 50A, and thus it is possible to sufficiently prevent damage of the connecting portion and the like during operation of the operating member 50A.

### Third Embodiment of Lock Device for Opening and Closing Body

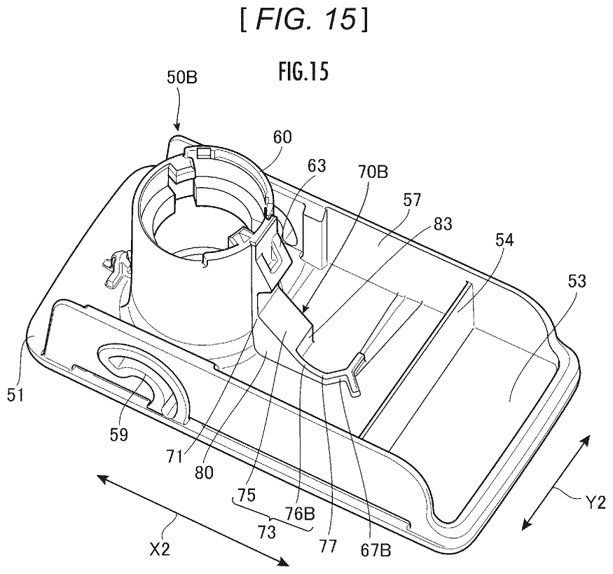

FIGS. 15 to 17 illustrate a third embodiment of the lock device for the opening and closing body according to the present invention. Note that the same reference sign will be given to substantially the same portion as in the above-described embodiment, and description thereof will be omitted.

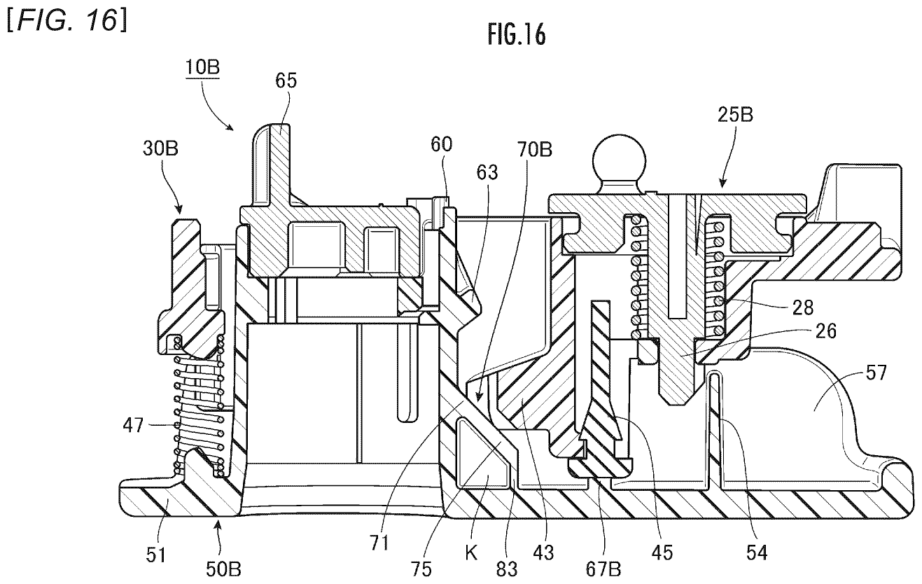

As shown in FIG. 16, a lock device 10B for an opening and closing body of the third embodiment (hereinafter, simply referred to as “lock device 10B”) is mainly different from the above-described embodiments in that a shape of a base member 30B and a shape of a second load transmission wall portion 70B (hereinafter, simply referred to as “second transmission wall portion 70B”) configuring an operating member 50B is different.

That is, as shown in FIG. 15, the base end 71 of the second transmission wall portion 70B in the embodiment is connected to a position away from the stopper portion 63 provided to be connected to the first transmission wall portion 60.

A tip end side in the extension direction of the first extension portion 75 obliquely extending from the base end 71 is connected to the operating plate portion 51 via the connecting rib 83. A second extension portion 76B having a protruding shape and connected to the rear surface of the operating plate portion 51 extends from one side of the connecting rib 83 in the width direction Y2. The tip end 77 of the second extension portion 76B in the extension direction is connected to a damper contact portion 67B connected to the rear surface of the operating plate portion 51 and having an approximately Y-shaped rib shape.

That is, in the embodiment, the connecting rib 83, the second extension portion 76B, and the damper contact portion 67B configure the “connecting portion” in the present invention.

As shown in FIG. 16, a rotation member 25B is mounted on a rear surface side (back surface side) of the base member 30B via a support shaft 26 to be rotatable. Note that a torsion spring 28 is mounted on the rotation member 25B, and the tip ends 22 and 22 of the pair of lock members 20 and 20 mounted on the rotation member 25B are rotationally biased in a direction to engage with the pair of lock portions 3 and 3.

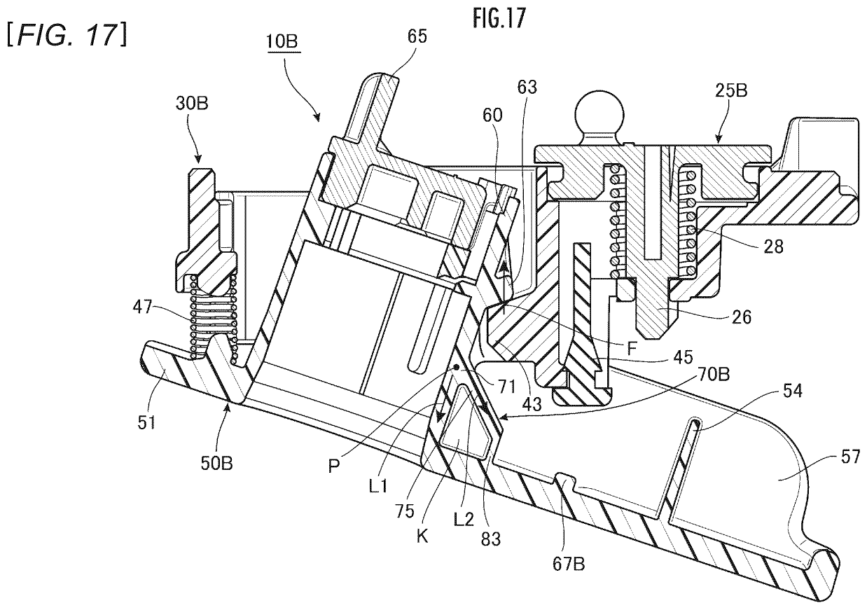

Then, when the operating member 50 is maximally rotated with respect to the base member 30 and the stopper portion 63 comes into contact with the stopper receiving portion 43 as shown in FIG. 17, the operating load F received by the stopper portion 63 is first transmitted to the first transmission wall portion 60. Then, the operating load F transmitted via the first transmission wall portion 60 is branched at the load branching portion P, and is dispersed to the first path L1 passing the first transmission wall portion 60 and the second path L2 passing the second transmission wall portion 70.

Then, the operating load F transmitted via the first path L1 is transmitted to the operating plate portion 51.

Meanwhile, the operating load F transmitted via the second path L2 passes the first extension portion 75, and a part of the operating load F is transmitted to the operating plate portion 51 via the connecting rib 83. The remaining part of the operating load F passes the second extension portion 76B and is transmitted to the operating plate portion 51 via the second extension portion 76B, and is transmitted to the operating plate portion 51 via the damper contact portion 67B after passing the second extension portion 76B.

In the embodiment, since the operating load F can be dispersed not only by the second transmission wall portion 70 but also by the damper contact portion 67B with which the damper 45 comes into contact, shape and structure of the operating member 50B can be simplified.

Note that the present invention is not limited to the above-described embodiments, and various modified embodiments are possible within the gist of the present invention, and such embodiments are also included in the scope of the present invention.

### REFERENCE SIGNS LIST

1: fixed body
2: opening
3: lock portion
4: opening and closing body
10, 10A, 10B: lock device for opening and closing body (lock device)
20: lock member
25, 25B: rotation member
30, 30B: base member
36; support protrusion (one of pivotally supporting portion)
50, 50A, 50B: operating member
51: operating plate portion
53: operating portion
54: partition wall portion
59: support groove (one of pivotally supporting portion)
60: first load transmission wall portion (first transmission wall portion)
63: stopper portion
70: second load transmission wall portion (second transmission wall portion)
71: base end
73: extension portion
75: first extension portion
76: second extension portion
77: tip end
80: side wall portion
83, 84: connecting rib

1. A lock device for an opening and closing body configured to be attached to an opening of a fixed body to be openable and closable, the lock device comprising:
a lock portion provided in one of the fixed body or the opening and closing body;
a lock member that is disposed in another of the fixed body or the opening and closing body and that is configured to engage with or disengage from the lock portion;
a base member fixed to the other of the fixed body or the opening and closing body; and
an operating member that is supported by the base member via a pivotally supporting portion to be rotatable and that is configured to operate the lock member, wherein
the operating member includes an operating plate portion extending in a plate shape, an operating portion provided in the operating plate portion, a first load transmission wall portion protruding from a rear side of the operating plate portion, a stopper portion provided to be connected to the first load transmission wall portion, and a second load transmission wall portion provided on the rear side of the operating plate portion,
the second load transmission wall portion has a base end connected to the first load transmission wall portion and/or the stopper portion, and includes an extension portion including a portion obliquely extending toward the operating plate portion and a connecting portion that connects the extension portion to the operating plate portion,
the base member includes a stopper receiving portion that is capable of coming into contact with the stopper portion and that is configured to restrict rotation of the operating member, and
a gap is formed between the first load transmission wall portion, the extension portion and the connecting portion of the second load transmission wall portion, and the operating plate portion.

2. The lock device for the opening and closing body according to claim 1, wherein a side wall portion that connects the operating plate portion to the first load transmission wall portion is provided in one side of the second load transmission wall portion in a width direction.

3. The lock device for the opening and closing body according to claim 1, wherein the connecting portion is formed to be thinner than a thickness of the extension portion.

4. The lock device for the opening and closing body according to claim 1, wherein, when a surface area of the second load transmission wall portion when viewed from a width direction is set as S1 and a surface area of the second load transmission wall portion when viewed from a thickness direction is set as S2, a relationship of S1<S2 is satisfied.

5. The lock device for the opening and closing body according to claim 1, wherein
a partition wall portion that partitions the operating plate portion and the operating portion is erected from the rear side of the operating plate portion, and
a tip end of the extension portion is connected to the partition wall portion and the partition wall portion configures the connecting portion.

6. The lock device for the opening and closing body according to claim 5, wherein a connecting rib that connects the extension portion to the operating plate portion is provided in the tip end of the extension portion on a side of the first load transmission wall portion with respect to a connecting potion with the partition wall portion and the tip end of the extension portion, and the connecting rib configures the connecting portion.
